(19) United States
(12) Patent Application Publication
(10) Pub. No.: US 2010/0302478 A1
(43) Pub. Date: Dec. 2, 2010

(54) LIQUID CRYSTAL DISPLAY DEVICE

(75) Inventors: Atsuo Nakagawa, Mobara (JP); Eiji Oohira, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/785,775

(22) Filed: May 24, 2010

(30) Foreign Application Priority Data
May 28, 2009 (JP) 2009-128427

(51) Int. Cl. G02F 1/1335

(52) U.S. Cl. 349/62

(57) ABSTRACT

Light emitting diodes mounted on a LED board are housed in the inside of a mold from a side of the mold opposite to a liquid crystal panel. The LED board and a reflection sheet are arranged such that a distal end portion of the LED board and the reflection sheet face each other while preventing the distal end portion of the LED board and a portion of the reflection sheet from overlapping with each other. A thickness of the light emitting diodes in the first direction orthogonal to the liquid crystal panel is larger than a thickness of a light incident surface of a light guide plate in the first direction. A region where the light emitting diodes are arranged protrudes more than a region where the light guide plate is arranged in a direction away from the liquid crystal panel.

### CROSS-REFERENCE TO RELATED APPLICATION

The present application claims priority from Japanese application JP2009-128427 filed on May 28, 2009, the content of which is hereby incorporated by reference into this application.

### BACKGROUND OF THE INVENTION

1. Field of the Invention

The present invention relates to a liquid crystal display device, and more particularly to a technique which is effectively applicable to a backlight of the liquid crystal display device.

2. Description of the Related Art

A TFT (Thin Film Transistor) method liquid crystal display device (also referred to as a liquid crystal display module) having a miniaturized liquid crystal panel has been popularly used as a display part of a portable device such as a mobile phone (see JP 2007-25484 A).

FIG. 7 is an exploded perspective view showing the schematic constitution of a conventional liquid crystal display device for a mobile phone.

As shown in FIG. 7, the conventional liquid crystal display device includes a liquid crystal panel (LCD) and a backlight (BL) which radiates light to the liquid crystal panel (LCD).

The backlight (BL) includes a light guide plate 6 having an approximately rectangular shape which is substantially equal to a planar shape of the liquid crystal panel (LCD), white light emitting diodes (light source; hereinafter referred to as LEDs) 8 which are arranged on one side surface (incident surface) of the light guide plate 6, a reflection sheet 7 which is arranged on a lower-surface-side of the light guide plate 6 (a surface of the light guide plate 6 on a side opposite to the liquid crystal panel (LCD)), a group of optical sheets 5 which is arranged on an upper surface of the light guide plate 6 (a liquid-crystal-panel-side surface of the light guide plate 6), and a resin mold frame (hereinafter, simply referred to as a mold) 10. The group of optical sheets 5 is constituted of a lower diffusion sheet, two lens sheets and an upper diffusion sheet, for example.

In the conventional liquid crystal display device, the group of optical sheets 5, the light guide plate 6 and the LEDs 8 are arranged in the inside of the mold 10 in the order shown in FIG. 7, and the reflection sheet 7 is arranged on a lower side of the mold 10.

Further, the liquid crystal panel (LCD) includes a pair of glass substrates (2a, 2b), an upper polarizer 1 which is adhered to an upper surface (display surface) of the glass substrate 2a, and a lower polarizer 3 which is adhered to a lower surface (a backlight-side surface) of the glass substrate 2b.

Further, a semiconductor chip (DRV) which constitutes a driver or the like is mounted on the glass substrate 2b. Here, although a flexible printed circuit board which supplies a control signal or the like to the semiconductor chip (DRV) is mounted on the glass substrate 2b, the illustration of the flexible printed circuit board is omitted from FIG. 7.

FIG. 8A and FIG. 8B are views showing a state where the flexible printed circuit board (FPC) is mounted on the glass substrate 2b of the conventional liquid crystal display device. FIG. 8A is a view as viewed from a front side (liquid-crystal-panel side), and FIG. 8B is a view as viewed from a back surface side (backlight side). Further, FIG. 9 is a cross-sectional view of an essential part showing the cross-sectional structure taken along a line IX-IX in FIG. 8A, and FIG. 10 is a plan view showing a developed state of the flexible printed circuit board (FPC) shown in FIG. 8A and FIG. 8B.

As shown in FIG. 10, the flexible printed circuit board (FPC) includes a connection part 21 which is provided for connecting flexible printed circuit board (FPC) to the glass substrate 2b, a body portion 20 which is provided with a connection part 22 for connecting the flexible printed circuit board (FPC) to an external device (for example, mobile phone), an LED board 24 on which the LEDs 8 are mounted, and a connection board 23 which connects the body portion 20 and the LED board 24 to each other. Here, the body portion 20, the connection board 23 and the LED board 24 are formed of a double-sided flexible printed circuit board respectively.

Further, as shown in FIG. 9, the connection board 23 is bent so that a plurality of (four in this embodiment) LEDs 8 mounted on the LED board 24 can be arranged in the inside of the mold 10 by inserting from a lower side of the mold 10. In FIG. 9, numeral 13 indicates a pressure sensitive double coated adhesive tape.

In the conventional liquid crystal display device, as a method for arranging the LEDs 8 on one side surface of the light guide plate 6, there have been known a method shown in FIG. 11 and a method shown in FIG. 12. In the method shown in FIG. 11, the LEDs 8 are arranged on one side surface of the light guide plate 6 such that a distal end portion of the LED board 24 overlaps with a portion of a reflection sheet 7. On the other hand, in the method shown in FIG. 12, the LEDs 8 are arranged on one side surface of the light guide plate 6 such that a distal end portion of the LED board 24 and the reflection sheet 7 face each other while preventing the distal end portion of the LED board 24 and a portion of the reflection sheet 7 from overlapping to each other. In FIG. 11 and FIG. 12, symbol t1 indicates a distance between a lower surface of the reflection sheet 7 and the light guide plate 6, symbol t2 indicates a thickness of the LED board 24, symbol t3 indicates a length of a non-light-emitting region of the LED 8 in the thickness direction (in the direction orthogonal to the liquid crystal panel: arrow A shown in FIG. 11, FIG. 12), symbol t4 indicates a length of a light emitting region of the LED 8 in the thickness direction, symbol t5 indicates a thickness (height) of the LED 8, and symbols t6, t7 indicate regions of the LED 8 which generates a light emission loss. Originally, the ideal positional relationship in the thickness direction between the light guide plate 6 and the LED 8 is a state where a center point of the light guide plate 6 in the thickness direction and a center point of the light emitting region of the LED 8 in the thickness direction are aligned with each other. However, in FIG. 11, out of light emitted from the LED 8, some light in the region t6 is not incident on the light guide plate 6 thus generating a light emission loss. On the other hand, in FIG. 12, out of light emitted from the LED 8, some light in the region t7 is not incident on the light guide plate 6 thus generating a light emission loss.

Here, assume that the length t4 is approximately equal to a thickness of a light incident surface of the light guide plate 6 (that is, when the thickness of the light incident surface of the light guide plate 6 is smaller than a thickness (height) of the LED 8), the relationship of t7>t6 is established. Accordingly, although the structure shown in FIG. 12 (the structure where the reflection sheet 7 and the distal end portion of the LED board 24 face each other in an opposed manner) has an advantage that the thickness of the whole liquid crystal display device can be reduced, the structure shown in FIG. 12 has a drawback that the light emission loss of light emitted from the LED 8 is large. In both the methods shown in FIG. 11 and FIG. 12, to completely eliminate the light emission loss of the LED 8, the thickness of the light guide plate 6 may be increased until a thickness of the region t6 or the region t7 becomes zero. However, these methods have a drawback that the thickness of the whole liquid crystal display device is increased.

### SUMMARY OF THE INVENTION

The present invention has been made to overcome the above-mentioned drawbacks of the related art, and it is an object of the present invention to provide a technique which can minimize, when a thickness of a light incident surface of a light guide plate is smaller than a height of a light emitting diode in a liquid crystal display device having a lower frame, a region where the thickness of the whole liquid crystal display device becomes large.

The above-mentioned and other objects and novel features of the present invention will become apparent from the description of this specification and attached drawings.

To briefly explain the summary of typical inventions among the inventions disclosed in this specification, they are as follows.

(1) According to one aspect of the present invention, there is provided a liquid crystal display device including: a liquid crystal panel which includes a first substrate, a second substrate and liquid crystal sandwiched between the first substrate and the second substrate; and a backlight, the liquid crystal panel including a flexible printed circuit board which is connected to one side of the first substrate, wherein the backlight includes a mold, a light guide plate which is arranged in the inside of the mold, n (≧2) pieces of light emitting diodes which are arranged on a side surface of the light guide plate in the inside of the mold, a reflection sheet which is arranged on a surface of the light guide plate on a side opposite to the liquid crystal panel, and a lower frame which houses the mold, the flexible printed circuit board includes a body portion which is connected to one side of the first substrate, a large-width LED board on which n pieces of light emitting diodes are mounted, and a connection board which connects the LED board and the body portion, the connection board is bent, and n pieces of light emitting diodes which are mounted on the LED board are housed in the inside of the mold from a side of the mold opposite to the liquid crystal panel, the LED board and the reflection sheet are arranged such that a distal end portion of the LED board and the reflection sheet face each other while preventing the distal end portion of the LED board and a portion of the reflection sheet from overlapping with each other, assuming a direction orthogonal to the liquid crystal panel as a first direction, a thickness of n pieces of light emitting diodes in the first direction is set larger than a thickness of a light incident surface of the light guide plate in the first direction, a region where n pieces of light emitting diodes are arranged protrudes more than a region where the light guide plate is arranged in the direction away from the liquid crystal panel, and the lower frame includes a protruding portion which protrudes in the direction away from the liquid crystal panel in the region where n pieces of light emitting diodes are arranged.

(2) In the liquid crystal display device having the constitution (1), the lower frame includes the plurality of protruding portions.

(3) According to another aspect of the present invention, there is provided a liquid crystal display device including: liquid crystal panel which includes a first substrate, a second substrate and liquid crystal sandwiched between the first substrate and the second substrate; and a backlight, the liquid crystal panel including a flexible printed circuit board which is connected to one side of the first substrate, wherein the backlight includes a mold, a light guide plate which is arranged in the inside of the mold, n (≧2) pieces of light emitting diodes which are arranged on a side surface of the light guide plate in the inside of the mold, a reflection sheet which is arranged on a surface of the light guide plate on a side opposite to the liquid crystal panel, and a lower frame which houses the mold, the flexible printed circuit board includes a body portion which is connected to one side of the first substrate, a large-width LED board on which n pieces of light emitting diodes are mounted, and a connection board which connects the LED board and the body portion, the connection board is bent, and n pieces of light emitting diodes which are mounted on the LED board are housed in the inside of the mold from a side of the mold opposite to the liquid crystal panel, the LED board and the reflection sheet are arranged such that a distal end portion of the LED board and the reflection sheet face each other while preventing the distal end portion of the LED board and a portion of the reflection sheet from overlapping with each other, assuming a direction orthogonal to the liquid crystal panel as a first direction, a thickness of n pieces of light emitting diodes in the first direction is set larger than a thickness of a light incident surface of the light guide plate in the first direction, a region where n pieces of light emitting diodes are arranged protrudes more than a region where the light guide plate is arranged in a direction away from the liquid crystal panel, and the lower frame includes an opening portion in the region where the respective light emitting diodes are arranged.

(4) In any one of the constitutions (1) to (3), the LED board is formed of a double-sided printed circuit board, and the connection board is formed of a single-sided printed circuit board.

(5) According to still another aspect of the present invention, there is provided a liquid crystal display device including: a liquid crystal panel which includes a first substrate, a second substrate and liquid crystal sandwiched between the first substrate and the second substrate; and a backlight, the liquid crystal panel including a flexible printed circuit board which is connected to one side of the first substrate, wherein the backlight includes a mold, a light guide plate which is arranged in the inside of the mold, n (≧2) pieces of light emitting diodes which are arranged on a side surface of the light guide plate in the inside of the mold, a reflection sheet which is arranged on a surface of the light guide plate on a side opposite to the liquid crystal panel, and a lower frame which houses the mold, the flexible printed circuit board includes a body portion which is connected to one side of the first substrate, a large-width LED board on which n pieces of light emitting diodes are mounted, and a connection board which connects the LED board and the body portion, the connection board is bent, and n pieces of light emitting diodes which are mounted on the LED board are housed in the inside of the mold from a side of the mold opposite to the liquid crystal panel, the LED board and the reflection sheet are arranged such that a distal end portion of the LED board and the reflection sheet face each other while preventing the distal end portion of the LED board and a portion of the reflection sheet from overlapping with each other, assuming a direction orthogonal to the liquid crystal panel as a first direction, a thickness of n pieces of light emitting diodes in the first direction is larger than a thickness of a light incident surface of the light guide plate in the first direction, a region where n pieces of light emitting diodes are arranged protrudes more than a region where the light guide plate is arranged in the direction away from the liquid crystal panel, and the lower frame protrudes in the direction away from the liquid crystal panel in an area from a side wall of the lower frame on one side of the first substrate to which the flexible printed circuit board is connected to the region where n pieces of light emitting diodes are arranged.

(6) In the constitution (5), the LED board and the connection board are formed of a double-sided printed circuit board respectively.

(7) In the constitution (6), the LED board and the connection board are integrally formed with each other.

(8) In any one of the constitutions (1) to (7), a center point of a thickness of a light emitting surface of n pieces of light emitting diodes in the first direction and a center point of a thickness of the light guide plate in the first direction are aligned with each other.

(9) In any one of the constitutions (1) to (8), the connection board is an elongated board having a board width smaller than a board width of the LED board.

To briefly explain the advantageous effects acquired by typical inventions among the inventions disclosed in this specification, they are as follows.

According to the present invention, in the liquid crystal display device having a lower frame, it is possible to minimize, when a thickness of a light incident surface of a light guide plate becomes smaller than a height of a light emitting diode, a region where the thickness of the whole liquid crystal display device becomes large.

### BRIEF DESCRIPTION OF THE DRAWINGS

FIG. 1 is an exploded perspective view showing the schematic constitution of a liquid crystal display device for a mobile phone according to an embodiment 1 of the present invention;

FIG. 2 is a view for explaining a method of arranging light emitting diodes on one side surface of a light guide plate of the liquid crystal display device according to the embodiment 1 of the present invention;

FIG. 3 is a cross-sectional view of an essential part showing the cross-sectional structure of the liquid crystal display device according to the embodiment 1 of the present invention;

FIG. 4 is a cross-sectional view of an essential part showing the cross-sectional structure of the liquid crystal display device according to an embodiment 2 of the present invention;

FIG. 5A and FIG. 5B are views for explaining a modification of a lower frame according to the embodiment 2 of the present invention;

FIG. 6A and FIG. 6B are views for explaining a lower frame according to an embodiment 3 of the present invention;

FIG. 7 is an exploded perspective view showing the schematic constitution of a conventional liquid crystal display device for a mobile phone;

FIG. 8A and FIG. 8B are views showing a state where a flexible printed circuit board (FPC) is mounted on a glass substrate of the conventional liquid crystal display device;

FIG. 9 is a cross-sectional view of an essential part showing the cross-sectional structure taken along a line IX-IX in FIG. 8A;

FIG. 10 is a plan view showing a developed state of the flexible printed circuit board (FPC) shown in FIG. 8A and FIG. 8B;

FIG. 11 is a view for explaining a method of arranging a light emitting diode on one side surface of the light guide plate of the conventional liquid crystal display device; and

FIG. 12 is a view for explaining another method of arranging a light emitting diode on one side surface of the light guide plate of the conventional liquid crystal display device.

### DESCRIPTION OF THE PREFERRED EMBODIMENTS

Hereinafter, embodiments of the present invention are explained in detail in conjunction with drawings.

Here, in all drawings for explaining the embodiments, parts having identical functions are given same symbols and their repeated explanation is omitted.

### Embodiment 1

A liquid crystal display device of this embodiment is a TFT method liquid crystal display device having a miniaturized liquid crystal panel, and is used as a display part of a portable device such as a mobile phone.

The liquid crystal display device of this embodiment is also constituted of a liquid crystal panel and a backlight which is arranged on a surface of the liquid crystal panel on a side opposite to a viewer.

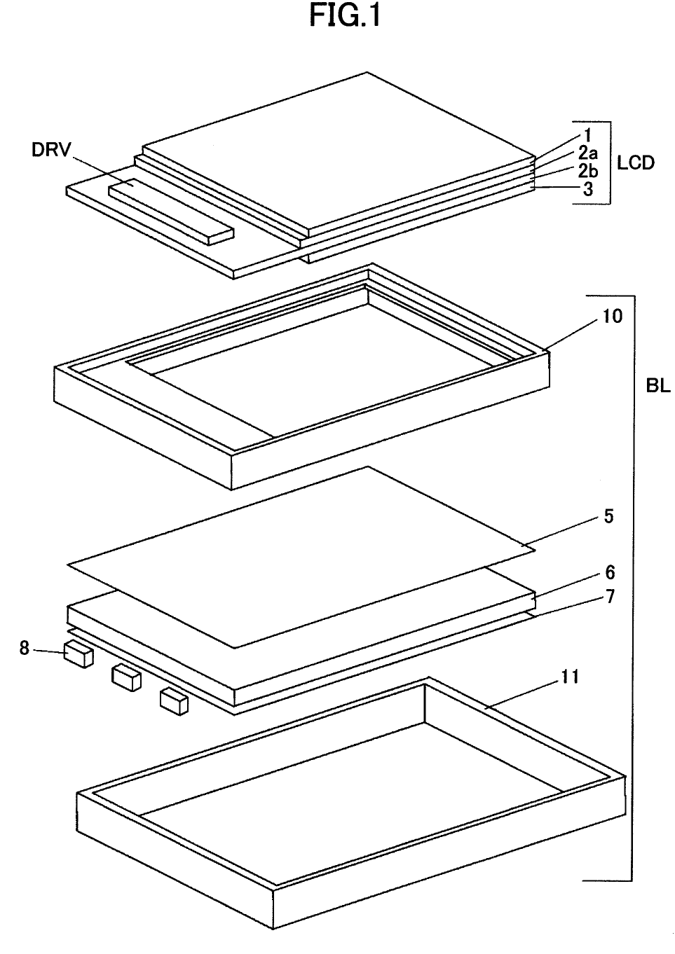

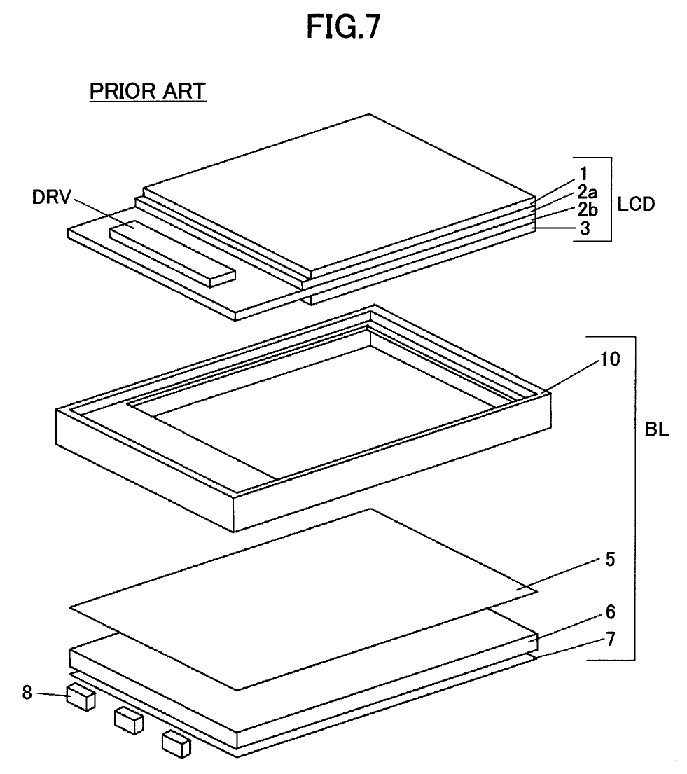

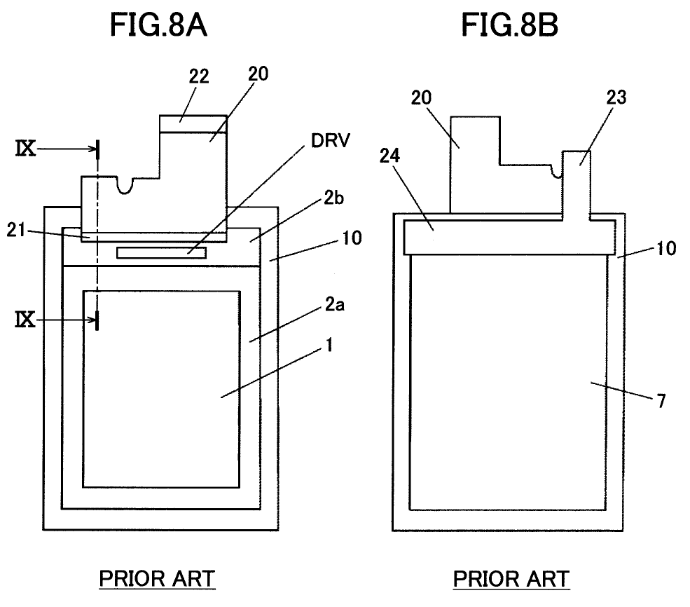

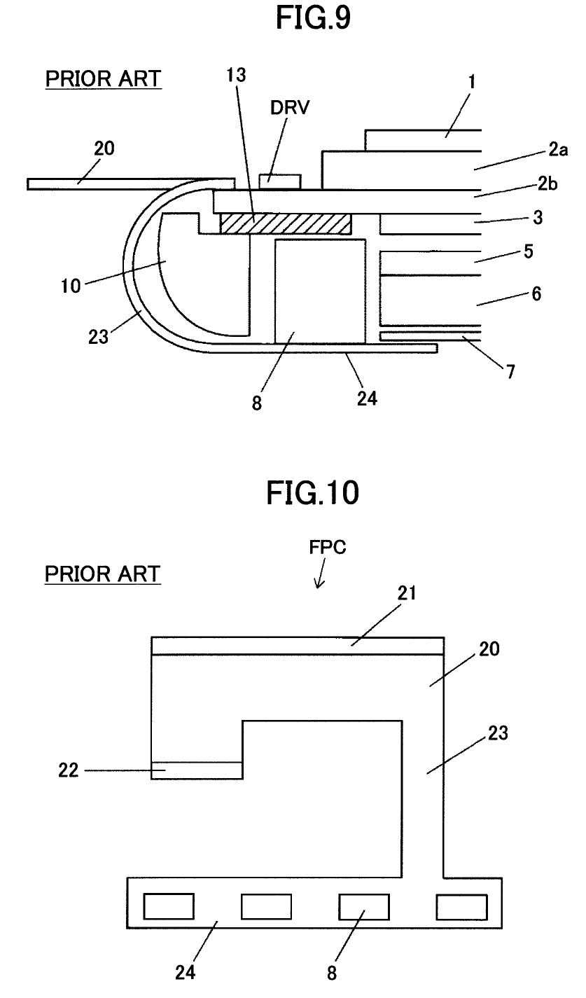

FIG. 1 is an exploded perspective view showing the schematic constitution of a liquid crystal display device for a mobile phone according to the embodiment of the present invention. The liquid crystal display device of this embodiment differs from the above-mentioned conventional liquid crystal display device shown in FIG. 7 with respect to a point that the backlight (BL) includes a lower frame 11. The lower frame 11 is formed into a boxed shape where side walls are raised from the periphery of a bottom surface thus forming a recessed portion. Here, the lower frame 11 is made of stainless steel or a stainless steel alloy.

The liquid crystal panel (LCD) is constituted as follows. A glass substrate (also referred to as a TFT substrate) 2b on which pixel electrodes, thin film transistors and the like are formed, and a glass substrate (also referred to as a counter substrate) 2a on which color filters and the like are formed are made to overlap with each other with a predetermined gap therebetween, and both substrates are adhered to each other using a frame-shaped sealing material disposed between peripheral portions of both substrates. Then, liquid crystal is filled and sealed in a space defined by both substrates and the sealing material through a liquid crystal filling port formed in a portion of the sealing material. Further, polarizers (1, 3) are adhered to outer sides of both substrates respectively.

Further, a semiconductor chip (DRV) which constitutes a driver or the like is mounted on the glass substrate 2b. Although a flexible printed circuit board which supplies a control signal or the like to the semiconductor chip (DRV) is mounted on one side of the glass substrate 2b, the illustration of the flexible printed circuit board is omitted from FIG. 1.

Further, it is sufficient that the substrate is made of an insulating material so that a material of the substrate is not limited to glass, and may be plastic or the like. Further, the color fillers may be mounted on a TFT substrate side instead of a counter substrate side.

In a TN method or a VA method liquid crystal panel, counter electrodes are formed on the counter substrate side. In the IPS method liquid crystal panel, counter electrodes are formed on the TFT substrate side. Here, since the present invention is irrelevant to the inner structure of the liquid crystal panel, the detailed explanation of the inner structure of the liquid crystal panel is omitted. Further, the present invention is applicable to a liquid crystal panel having any structure.

In the liquid crystal display device of this embodiment, the backlight (BL) includes a group of optical sheets 5, a light guide plate 6, a reflection sheet 7 which is arranged below the light guide plate 6, and white light emitting diodes (hereinafter referred to as LEDs) 8 which are arranged on a side surface of the light guide plate 6. Here, the group of optical sheets 5 is constituted of a lower diffusion sheet, two lens sheets and an upper diffusion sheet, for example.

In the same manner as the conventional liquid crystal display device, the backlight of this embodiment is configured such that the group of optical sheets 5, the light guide plate 6 and the reflection sheet 7 are arranged in the inside of a mold 10 in the order shown in FIG. 7.

Further, the LEDs 8 are mounted on an LED board 24, and are arranged on the side surface of the light guide plate 6 in the inside of the mold 10 by inserting from a lower side of the mold 10. Here, the reflection sheet 7 is adhered (or tackily adhered) and is fixed to the mold 10 using a pressure sensitive double coated adhesive tape (attaching member).

In this embodiment, the group of optical sheets 5, the light guide plate 6 and LEDs 8 are arranged in the inside of the mold 10 in the order shown in FIG. 1, and the reflection sheet 7 is arranged below the mold 10. These elements are arranged in the recessed portion of the lower frame 11.

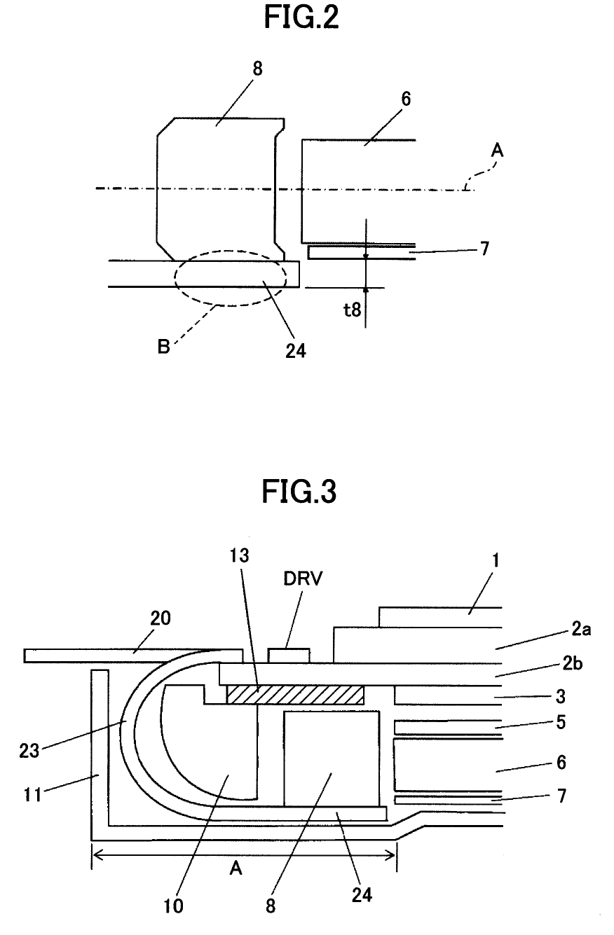

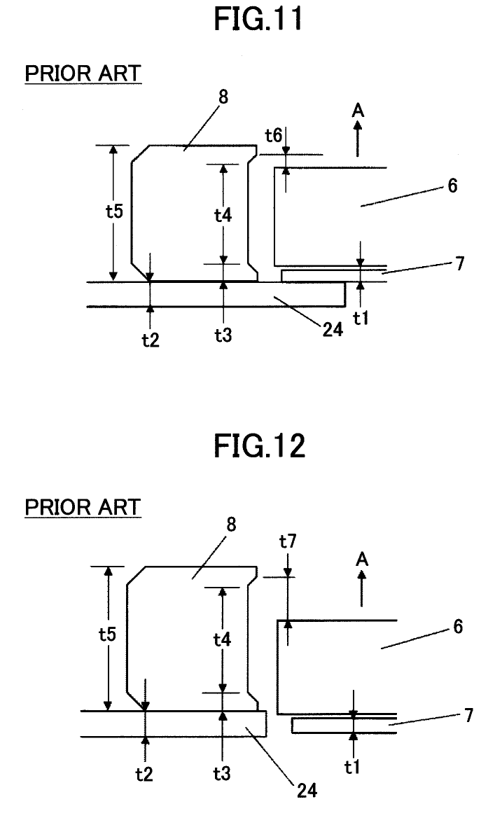

FIG. 2 is a view for explaining a method of arranging light emitting diodes on one side surface of the light guide plate in the liquid crystal display device of this embodiment. Originally, the ideal positional relationship in the thickness direction (direction orthogonal to the liquid crystal panel; direction indicated by an arrow A in FIG. 11 and FIG. 12) between the light guide plate 6 and the LEDs 8 is a state where a center point of the light guide plate 6 in the thickness direction and a center point of a light emitting region of the LEDs 8 in the thickness direction are aligned with each other. To acquire this state, in this embodiment, as indicated by “A” in FIG. 2, the light guide plate 6 and the LEDs 8 are arranged such that the center point of the light guide plate 6 in the thickness direction and the center point of the light emitting region of the LEDs 8 in the thickness direction are aligned with each other. In this specification, the explanation is made with respect to a case where the relationship that a thickness of the light emitting region of the LED is approximately equal to a thickness of the light incident surface of the light guide plate is satisfied. In this case, however, as shown in “B” in FIG. 2, in this embodiment, the LED board 24 on which the LEDs 8 are mounted protrudes downward. In this embodiment, a body portion 20, a connection board 23 and the LED board 24 of the flexible printed circuit board (FPC) are formed of a double-sided flexible printed circuit board respectively.

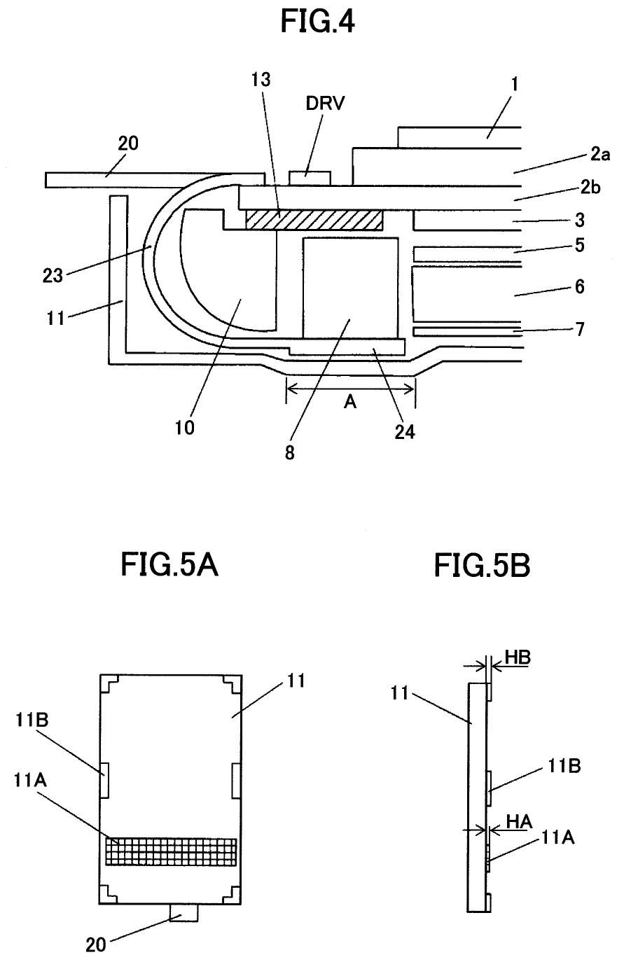

In view of the above-mentioned constitution, in this embodiment, as shown in FIG. 3, the lower frame 11 protrudes downward (in the direction away from the liquid crystal panel (LCD)) in an area ranging from a side wall thereof on one side of the first substrate 2b to which the flexible printed circuit board (FPC) is connected to a region thereof where the respective LEDs 8 are arranged (an area indicated by symbol A in FIG. 3). Here, FIG. 3 is a cross-sectional view of an essential part showing the cross-sectional structure of the liquid crystal display device according to the embodiment 1 of the present invention. Further, in FIG. 3 and FIG. 4 described later, numeral 13 indicates a pressure sensitive double coated adhesive tape. Due to such a constitution, in this embodiment, even when the light guide plate 6 whose light incident surface has a small thickness compared to a thickness (height) of the LED 8 is used, it is possible to align the center point of the light emitting region of the LEDs 8 in the thickness direction and the center point of the light incident surface of the light guide plate 6 in the thickness direction with each other. Accordingly, it is possible to allow the light emitted from the respective LEDs 8 to be incident on the light guide plate 6 while miniaturizing a light emission loss. Further, the lower frame 11 protrudes downward in the region where the LEDs 8 are mounted by applying drawing or the like to the lower frame 11 and hence, in the liquid crystal display device having the lower frame, it is possible to minimize a region where a total thickness of the liquid crystal display device is increased.

### Embodiment 2

FIG. 4 is a cross-sectional view of an essential part showing the cross-sectional structure of a liquid crystal display device according to an embodiment 2 of the present invention. Also in this embodiment, as indicated by “A” in FIG. 2, a light guide plate 6 and LEDs 8 are arranged such that a center point of the light guide plate 6 in the thickness direction and a center point of a light emitting region of the LEDs 8 in the thickness direction are aligned with each other. However, as indicated by “B” in FIG. 2, an LED board 24 on which the LEDs 8 are mounted protrudes downward in this embodiment. In this embodiment, a body portion 20 and the LED board 24 of a flexible printed circuit board (FPC) are formed of a double-sided flexible printed circuit board respectively, while a connection board 23 of the flexible printed circuit board (FPC) is formed of a single-sided flexible printed circuit board. In view of the above-mentioned constitution, in this embodiment, as shown in FIG. 4, a lower frame 11 protrudes downward (in the direction away from a liquid crystal panel (LCD)) in a region where the respective LEDs 8 are arranged (a region indicated by symbol A in FIG. 4). Due to such a constitution, also in this embodiment, even when the light guide plate 6 whose light incident surface has a small thickness compared to a thickness (height) of the LED 8 is used, it is possible to align the center point of the light emitting region of the LEDs 8 in the thickness direction and the center point of the light incident surface of the light guide plate 6 in the thickness direction with each other. Accordingly, it is possible to allow light emitted from the respective LEDs 8 to be incident on the light guide plate 6 while miniaturizing a light emission loss. Further, the lower frame 11 protrudes downward in the region where the LEDs 8 are mounted by applying drawing or the like to the lower frame 11 and hence, in the liquid crystal display device having the lower frame, it is possible to minimize a region where a total thickness of the liquid crystal display device is increased.

### Modification of Embodiment 2

FIG. 5A and FIG. 5B are views for explaining a modification of the lower frame according to the embodiment 2 of the present invention, wherein FIG. 5A is a view of the lower frame 11 as viewed from below, and FIG. 5B is a side view of the lower frame 11. In the structure of the lower frame 11 of this embodiment in which portions of the lower frame 11 in regions where the respective LEDs 8 are arranged protrude downward, an external force applied to a whole back surface of the lower frame 11 concentrates on downward protruding portions 11A of the lower frame 11 corresponding to the regions where the respective LEDs 8 are arranged (hereinafter, referred to as projecting portions of an LED mounting portion). In view of such concentration of the external force, as shown in FIG. 5A and FIG. 5B, a plurality of projecting portions 11B having a size equal to or larger than a size of the protruding portions 11A of the LED mounting portion are formed. In the modification shown in FIG. 5A and FIG. 5B, the external force applied to the whole back surface of the lower frame 11 is dispersed and hence, it is possible to prevent the external force applied to the whole back surface of the lower frame 11 from being concentrated on the protruding portion 11A of the LED mounting portion. Here, a height of the projecting portion 11B (a height indicated by symbol HB in FIG. 5B) is set equal to a height of the protruding portion 11A (a height indicated by symbol HA in FIG. 5B) or is set to 0.01 mm or more.

### Embodiment 3

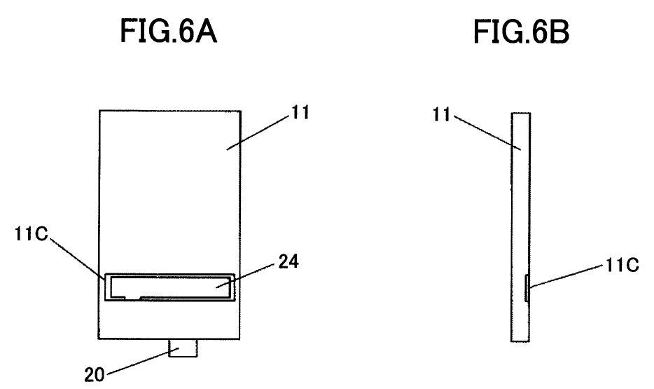

FIG. 6A and FIG. 6B are views for explaining a lower frame according to an embodiment 3 of the present invention, wherein FIG. 6A is a view of the lower frame 11 as viewed from below, and FIG. 6B is a side view of the lower frame 11. Also in this embodiment, as indicated by “A” in FIG. 2, a light guide plate 6 and LEDs 8 are arranged such that a center point of the light guide plate 6 in the thickness direction and a center point of a light emitting region of the LEDs 8 in the thickness direction are aligned with each other. However, as indicated by “B” in FIG. 2, an LED board 24 on which the LEDs 8 are mounted protrudes downward in this embodiment. In this embodiment, a body portion 20 and the LED board 24 of a flexible printed circuit board (FPC) are formed of a double-sided flexible printed circuit board respectively, while a connection board 23 of the flexible printed circuit board (FPC) is formed of a single-sided flexible printed circuit board. In view of the above-mentioned constitution, in this embodiment, as shown in FIG. 6A and FIG. 6B, an opening portion 11C is formed in the lower frame 11 in a region where the respective LEDs 8 are arranged (a region indicated by symbol “A” in FIG. 4). Due to such a constitution, also in this embodiment, even when the light guide plate 6 whose light incident surface has a small thickness compared to a thickness (height) of the LED 8 is used, it is possible to align the center point of the light emitting region of the LEDs 8 in the thickness direction and the center point of the light incident surface of the light guide plate 6 in the thickness direction with each other. Accordingly, it is possible to allow light emitted from the respective LEDs 8 to be incident on the light guide plate 6 while miniaturizing a light emission loss. Further, the opening portion 11C is formed in the lower frame 11 in the region where the LEDs 8 are mounted by applying drawing or the like to the lower frame 11 and hence, in the liquid crystal display device having the lower frame, it is possible to minimize a region where a total thickness of the liquid crystal display device is increased.

The explanation has been made heretofore with respect to the case where the center point of the light emitting region of the LEDs 8 in the thickness direction and the center point of the light guide plate 6 in the thickness direction are aligned with each other. However, there may be a case where the center point of the light emitting region of the LEDs 8 in the thickness direction and the center point of the light guide plate 6 in the thickness direction are not aligned with each other because of variation in size among respective parts or the like. The present invention is also applicable to a case where such misalignment takes place and the LED board 24 on which the LEDs 8 are mounted protrudes downward. That is, by protruding the lower frame 11 downward in the region where the LEDs 8 are mounted, or by forming the opening portion 11C in the lower frame 11 in the region where the LEDs 8 are mounted, in the liquid crystal display device having the lower frame, it is possible to minimize a region where a total thickness of the liquid crystal display device is increased. Although the inventions made by inventors of the present invention have been specifically explained in conjunction with the embodiments heretofore, it is needless to say that the present invention is not limited to the above-mentioned embodiments and various modifications are conceivable without departing from the gist of the present invention.

What is claimed is:

1. A liquid crystal display device comprising:
a liquid crystal panel which includes a first substrate, a second substrate and liquid crystal sandwiched between the first substrate and the second substrate;
a backlight; and
a flexible printed circuit board which is connected to one side of the first substrate, wherein
the backlight includes a mold, a light guide plate which is arranged in the inside of the mold, a plurality of light emitting diodes which are arranged on a side surface of the light guide plate in the inside of the mold, a reflection sheet which is arranged on a surface of the light guide plate on a side opposite to the liquid crystal panel, and a lower frame which houses the mold,
the flexible printed circuit board includes a body portion which is connected to one side of the first substrate, a large-width LED board on which the plurality of light emitting diodes are mounted, and a connection board which connects the LED board and the body portion,
the connection board is bent, and the plurality of light emitting diodes which are mounted on the LED board are housed in the inside of the mold from a side of the mold opposite to the liquid crystal panel,
the LED board and the reflection sheet are arranged such that a distal end portion of the LED board and the reflection sheet face each other while preventing the distal end portion of the LED board and a portion of the reflection sheet from overlapping with each other,
assuming a direction orthogonal to the liquid crystal panel as a first direction, a thickness of the plurality of light emitting diodes in the first direction is set larger than a thickness of a light incident surface of the light guide plate in the first direction,
a region where the plurality of light emitting diodes are arranged protrudes more than a region where the light guide plate is arranged in a direction away from the liquid crystal panel, and
the lower frame includes a protruding portion which protrudes in the direction away from the liquid crystal panel in the region where the plurality of light emitting diodes are arranged.

2. The liquid crystal display device according to claim 1, wherein the lower frame includes the plurality of protruding portions.

3. A liquid crystal display device comprising:
a liquid crystal panel which includes a first substrate, a second substrate and liquid crystal sandwiched between the first substrate and the second substrate;
a backlight; and
a flexible printed circuit board which is connected to one side of the first substrate, wherein
the backlight includes a mold, a light guide plate which is arranged in the inside of the mold, a plurality of light emitting diodes which are arranged on a side surface of the light guide plate in the inside of the mold, a reflection sheet which is arranged on a surface of the light guide plate on a side opposite to the liquid crystal panel, and a lower frame which houses the mold,
the flexible printed circuit board includes a body portion which is connected to one side of the first substrate, a large-width LED board on which the plurality of light emitting diodes are mounted, and a connection board which connects the LED board and the body portion,
the connection board is bent, and the plurality of light emitting diodes which are mounted on the LED board are housed in the inside of the mold from a side of the mold opposite to the liquid crystal panel,
the LED board and the reflection sheet are arranged such that a distal end portion of the LED board and the reflection sheet face each other while preventing the distal end portion of the LED board and a portion of the reflection sheet from overlapping with each other,
assuming a direction orthogonal to the liquid crystal panel as a first direction, a thickness of the plurality of light emitting diodes in the first direction is set larger than a thickness of a light incident surface of the light guide plate in the first direction,
a region where the plurality of light emitting diodes are arranged protrudes more than a region where the light guide plate is arranged in a direction away from the liquid crystal panel, and
the lower frame includes an opening portion in the region where the respective light emitting diodes are arranged.

4. The liquid crystal display device according to claim 1, wherein the LED board is formed of a double-sided printed circuit board, and the connection board is formed of a single-sided printed circuit board.

5. The liquid crystal display device according to claim 3, wherein the LED board is formed of a double-sided printed circuit board, and the connection board is formed of a single-sided printed circuit board.

6. A liquid crystal display device comprising:
a liquid crystal panel which includes a first substrate, a second substrate and liquid crystal sandwiched between the first substrate and the second substrate;
a backlight; and
a flexible printed circuit board which is connected to one side of the first substrate, wherein
the backlight includes a mold, a light guide plate which is arranged in the inside of the mold, a plurality of light emitting diodes which are arranged on a side surface of the light guide plate in the inside of the mold, a reflection sheet which is arranged on a surface of the light guide plate on a side opposite to the liquid crystal panel, and a lower frame which houses the mold,
the flexible printed circuit board includes a body portion which is connected to one side of the first substrate, a large-width LED board on which the plurality of light emitting diodes are mounted, and a connection board which connects the LED board and the body portion,
the connection board is bent, and the plurality of light emitting diodes which are mounted on the LED board are housed in the inside of the mold from a side of the mold opposite to the liquid crystal panel,
the LED board and the reflection sheet are arranged such that a distal end portion of the LED board and the reflection sheet face each other while preventing the distal end portion of the LED board and a portion of the reflection sheet from overlapping with each other,
assuming a direction orthogonal to the liquid crystal panel as a first direction, a thickness of the plurality of light emitting diodes in the first direction is set larger than a thickness of a light incident surface of the light guide plate in the first direction,
a region where the plurality of light emitting diodes are arranged protrudes more than a region where the light guide plate is arranged in a direction away from the liquid crystal panel, and
the lower frame protrudes in the direction away from the liquid crystal panel in an area ranging from a side wall of the lower frame on one side of the first substrate to which the flexible printed circuit board is connected to the region where the plurality of light emitting diodes are arranged.

7. The liquid crystal display device according to claim 6, wherein the LED board and the connection board are formed of a double-sided printed circuit board respectively.

8. The liquid crystal display device according to claim 7, wherein the LED board and the connection board are integrally formed with each other.

9. The liquid crystal display device according to claim 1, wherein a center point of a thickness of a light emitting surface of the plurality of light emitting diodes in the first direction and a center point of a thickness of the light guide plate in the first direction are aligned with each other.

10. The liquid crystal display device according to claim 3, wherein a center point of a thickness of a light emitting surface of the plurality of light emitting diodes in the first direction and a center point of a thickness of the light guide plate in the first direction are aligned with each other.

11. The liquid crystal display device according to claim 6, wherein a center point of a thickness of a light emitting surface of the plurality of light emitting diodes in the first direction and a center point of a thickness of the light guide plate in the first direction are aligned with each other.

12. The liquid crystal display device according to claim 1, wherein the connection board is an elongated board having a board width smaller than a board width of the LED board.

13. The liquid crystal display device according to claim 3, wherein the connection board is an elongated board having a board width smaller than a board width of the LED board.

14. The liquid crystal display device according to claim 6, wherein the connection board is an elongated board having a board width smaller than a board width of the LED board.
